(19) United States
(12) Patent Application Publication
(10) Pub. No.: US 2022/0277089 A1
(43) Pub. Date: Sep. 1, 2022

(54) COMMUNICATIONS SERVER APPARATUS AND METHOD FOR DETERMINATION OF AN ABSTENTION ATTACK

(71) Applicant: GRABTAXI HOLDINGS PTE. LTD., Singapore (SG)

(72) Inventors: Prasanna KANAGASABAI, Singapore (SG); Somesh PATHAK, Singapore (SG); Sreekanth NARAYANAN, Singapore (SG)

(21) Appl. No.: 17/637,464

(22) PCT Filed: Sep. 2, 2019
(86) PCT No.: PCT/SG2019/050436

§ 371 Date: Feb. 23, 2022

(51) Int. Cl. G06F 21/60; G06F 21/64; G06F 21/44; G06F 21/31; G06F 21/56

(52) U.S. Cl. CPC G06F 21/606; G06F 21/64; G06F 21/44; G06F 21/31; G06F 21/566

(57) ABSTRACT

A communications server apparatus for determination of an abstention attack associated with a user communications device, configured to transmit handshake data to the user communications device, monitor, for a defined time duration, for a handshake response from the user communications device corresponding to the handshake data, and in response to expiry of the defined time duration with no handshake response corresponding to the handshake data being received by the communications server apparatus, and, further, in response to the communications server apparatus determining presence of an event that is indicative of the user communications device being in a communication mode with the communications server apparatus, determine that there is the abstention attack, and generate termination data in response to the determination of the abstention attack for denying the user communications device access to a service associated with the communications server apparatus.

### TECHNICAL FIELD

The invention relates generally to the field of communications. One aspect of the invention relates to a communications server apparatus for determination of an abstention attack associated with a user communications device. Another aspect of the invention relates to a method for determination of an abstention attack associated with a user communications device.

One aspect of the invention has particular, but not exclusive, application to determining receipt of a response or payload in a handshake process, and/or determining an abstention attack in the absence of appropriate response/payload upon expiry of a defined time duration.

### BACKGROUND

Mobile fraud is a significant source of revenue drain for companies. As organisations use mobile apps as their primary consumer interface, they also have to build solid strategies to deal with fraud emanating from the platforms.

While fraud prevention systems are employed by organisations, as malicious actors have advanced their understanding and skills of countering such systems, “abstention” attacks have increased. Abstention attacks are methods of circumventing controls of a fraud prevention system by not participating in data collection exercise associated with the system. These can take multiple forms, for example,
The attacker alters the application in such a way that data collection is stopped;
The attacker alters the application in such a way that the data dispatch routine is stopped;
The attacker is able to manipulate the communication channel to the server and redirect the specific data egress elsewhere or cut it off, causing full packet loss to the intended server.

Though there are variations of this attack on the client, the symptoms observed on the server is a lack of communication from the fraudster in terms of the data collection exercise.

Fraud prevention solutions have ignored the abstention problem as it is difficult to monitor. Product companies ignore it because it's a complex problem to fix unless one has control over all components. Typically, the assumption is that the payload to the server is always sent, and once this barrier is broken, the systems do not offer a way to detect or remediate this situation. In such cases, the fraudster continues to communicate with the services and receive normal functionality, even though they have circumvented detection. Typical type of frauds may include spoofing location or modifying a service provider's App (Application) so that one can cherry pick certain options (e.g., services) that suit the person, for example, travel-related services or rides, which lead to financial loss for the service provider.

It is therefore desirable to address at least some of the issues mentioned above.

### SUMMARY

Aspects of the invention are as set out in the independent claims. Some optional features are defined in the dependent claims.

Implementation of the techniques disclosed herein may provide significant technical advantages. These may include a communications server apparatus sending handshake data to a user communications device (with an expectation of a handshake response/payload in response thereto and corresponding to the handshake data in normal circumstances), determining that there is an abstention attack associated with the user communications device when no appropriate response/payload has been received from the user communications device upon expiry of a defined time duration, and subsequently generating termination data that allows blocking access by the user communications device to the communications server apparatus or the services associated with the communications server apparatus.

In at least some implementations, the techniques disclosed herein may provide for nonce to be transmitted to the user communications device (e.g., included with the handshake data) so that a replay attack can be avoided by preventing old communication or response from being reused to gain access to the communications server apparatus or the services associated therewith.

In at least some implementations, the techniques disclosed herein may allow buffer for potential network issues, e.g., slow network connections, by implementing a suitable timeframe or duration beyond which an abstention attack may be flagged if there has been no suitable response from the user communications device.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a communications server apparatus for determination of an abstention attack associated with a user communications device.

FIG. 2B shows a flow chart illustrating a method performed in a communications server apparatus for determination of an abstention attack associated with a user communications device.

FIG. 3A shows a schematic diagram illustrating a benign App flow sequence.

FIG. 3B shows a schematic diagram illustrating an abstention App flow sequence.

### DETAILED DESCRIPTION

Various embodiments may relate to apparatus and methodology to detect and prevent an abstention attack, e.g., on a distributed mobile fraud prevention network.

Various embodiments may relate to fraud checking in a mobile system. There may be provided fraud detection systems which may require a component on the mobile device (or communication device) that acts like an “agent” to collect data and send the collected data securely to a centralised or distributed processing system. The data that may be collected may include, but not limited to, Application checksums to detect if the Application (App) used to communicate with the server is or has been modified, sensor information for checking if a device is rooted/jailbroken, and the DeviceID that is created. The agent may be more secure than the App, so as to be less prone to modification. The agent may be, for example, a piece of C++ code with protections in place to protect itself.

In various embodiments, the mobile system may authenticate a user on the system, access to the system is granted and the system may record the user's presence in a data store. For the purposes of a fraud check, separate from the login/authentication process, a fraud detection system initiates a handshake with the user, sending what is effectively a handshake invitation. The fraud detection system monitors for receipt of a handshake response which, in a preferred arrangement, includes some data from the agent on the user's device. A benign user will send a handshake response back, and receipt of the response is detected. In a preferred arrangement, the response—or at least the fact a response has been received—is recorded in the data store. Malignant users commonly seek to evade sending the response. If the handshake response is not detected within a specific timeframe, the user is identified as a potentially malignant actor and system access for the user is revoked.

Effectively, the handshake initiation may serve to solicit a specific or defined response which the system may be expecting, along with, preferably, information or some data from the “agent” on the device. All normal or non-malicious clients (or users) are expected to respond with data from the device (e.g., checksum to check if the app is not modified, data to check if the device is rooted/jailbroken, etc). As malicious actors try to avoid sending a handshake response, the system may effectively detect the unwillingness on the part of the actor to send the “payload” (e.g., data from the agent) to the system.

Once it is determined or detected that there is an abstention attack, communication from the bad actor (via a user communications device) may be terminated, or all sessions from the bad actor (e.g., initiated with one or more (micro)services) may be terminated or dropped. Effectively, the bad actor may be evicted from the system.

The present techniques may implement a time bound handshake process between different systems to detect an abstention attack (which will be described in detail further below). Once an abstention attack is detected, the systems may evict such malignant or malicious actors (or users) by terminating the active sessions that the users hold with any micro services. The present techniques may provide one or more of the following:
(i) Address a problem that has been ignored, for example, in the mobile fraud prevention space;
(ii) A flexible design that may allow fine tuning of different parameters to allow for false positive correction (for example, due to slow network connections etc);
(iii) Near 100% detection rate for the specific problem being addressed. This refers to a situation where the techniques or systems may return a false positive, as opposed to missing a bad actor or failing to pick up a malicious user.

In terms of the flexible design, this may include tuning of the timing parameter and/or the flexibility to do the fraud check at any stage. For example, the defined time duration before the check for abstention attack may factor in any potential delay in processing and data travel times. Further, there may be checking of whether the actor/user is working on any other service(s) but did not send the required security payload in the handshake process, which is then clear indication of attack and action would be taken against the user.

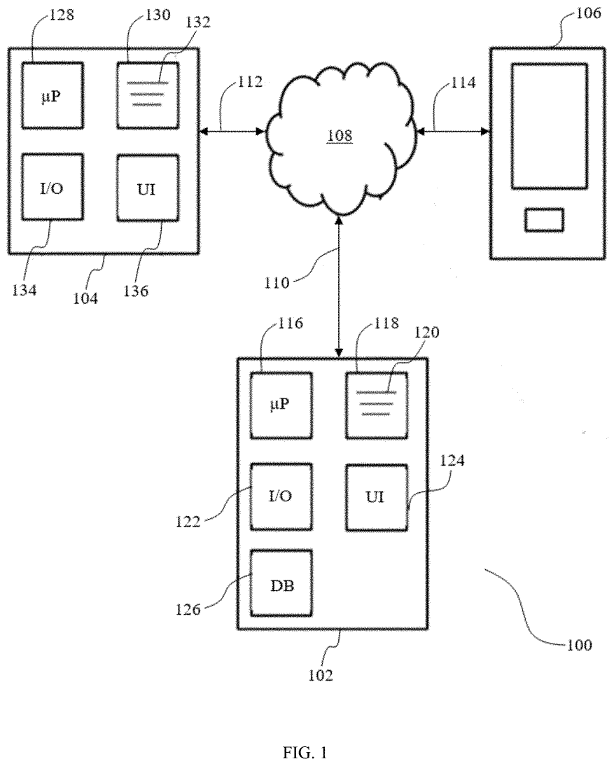

Referring first to FIG. 1, a communications system 100 is illustrated, which may be applicable in various embodiments. The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be for determination of an abstention attack associated with a user communications device (e.g., 104 and/or 106).

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (μP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like.

The user communications device 106 may be, for example, a smart phone or tablet device with the same or a similar hardware architecture to that of the user communications device 104.

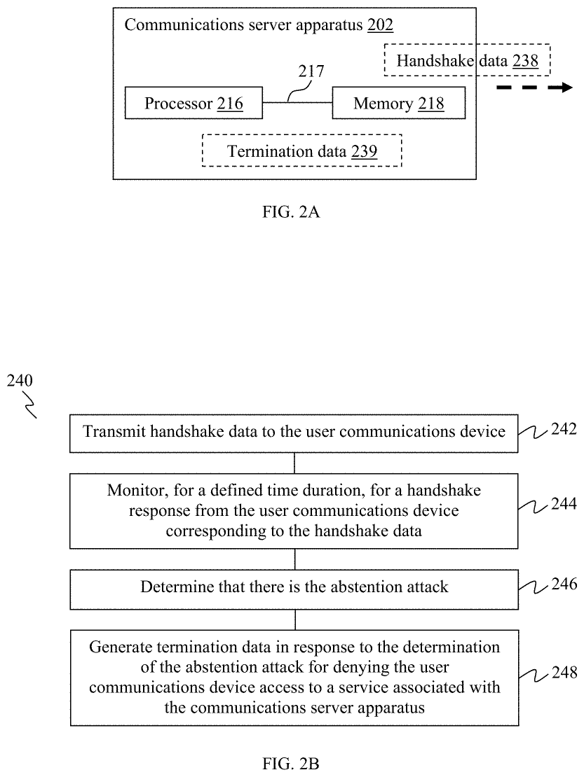

FIG. 2A shows a schematic block diagram illustrating a communications server apparatus 202 for determination of an abstention attack associated with a user communications device. The communications server apparatus 202 includes a processor 216 and a memory 218, where the communications server apparatus 202 is configured, under control of the processor 216 to execute instructions in the memory 218 to, transmit handshake data 238 to the user communications device, monitor, for a defined time duration, for a handshake response from the user communications device corresponding to the handshake data 238, in response to expiry of the defined time duration with no handshake response corresponding to the handshake data 238 being received by the communications server apparatus 202, and, further, in response to the communications server apparatus 202 determining presence of an event that is indicative of the user communications device being in a communication mode with the communications server apparatus 202, determine that there is the abstention attack, and generate termination data 239 in response to the determination of the abstention attack for denying the user communications device access to a service associated with the communications server apparatus 202. The processor 216 and the memory 218 may be coupled to each other (as represented by the line 2179), e.g., physically coupled and/or electrically coupled. The processor 216 may be as described in the context of the processor 116 (FIG. 1) and/or the memory 218 may be as described in the context of the memory 118 (FIG. 1).

In other words, a communications server apparatus 202 may be provided. The communications server apparatus 202 may be configured to detect an abstention attack associated with or originating from a user communications device (e.g., 104, 106, FIG. 1). The user of the user communications device may, for example, try to gain access to one or more (micro)services associated with or provided by the communications server apparatus 202. The communications server apparatus 202 may transmit handshake data 238 to be received by the user communications device (e.g., the communications server apparatus 202 may transmit the handshake data 238 as part of a handshake process, or the communications server apparatus 202 may initiate a handshake process by transmitting the handshake data 238). The communications server apparatus 202 may then monitor, for a defined (or predetermined) time duration, for a handshake response (e.g., which may be or may include a payload) from the user communications device in response to the handshake data 238. The handshake response may be specific to the handshake data 238. The handshake response may be transmitted by the user communications device to the communications server apparatus 202 as part of the handshake process.

In various embodiments, the handshake data 238 may be transmitted to the user communications device in response to the communications server apparatus 202 authenticating a user of the user communications device, or at any time after the authentication process.

If the defined time duration (or a certain time period) has passed or elapsed (i.e., expired) without the communications server apparatus 202 having received the handshake response from the user communications device corresponding to the handshake data 238, and, further, in response to the communications server apparatus 202 having determined or detected presence (or existence) of an event (e.g., a communication or network event) that is indicative of the user communications device being in a communication mode with the communications server apparatus 202, the communications server apparatus 202 may determine that the abstention attack has occurred, and, following from that, the communications server apparatus 202 may generate termination data 239 for blocking access by the user communications device to a service (e.g., microservice) associated with the communications server apparatus 202. Access by the user communications device to one or more or all (micro)services associated with the communications server apparatus 202 may be denied. The termination data 239 may include or may be indicative of an eviction verdict or notification.

In greater detail, if no appropriate response is received by the communications server apparatus 202 from the user communications device corresponding to the handshake data 238 before expiration of the defined time duration, the communications server apparatus 202 may determine whether there may be an event that provides an indication that the user communications device is in a communication mode with the communications server apparatus 202, i.e., whether the user communications device may be in a state of communication with the communications server apparatus 202, or in a state that is capable of communication with the communications server apparatus 202. If it is determined that there is such an event, the communications server apparatus 202 proceeds to deny access to a service associated with the communications server apparatus by generating the termination data 239 as the communications server apparatus 202 may recognise the presence of such event, combined with the lack of a handshake response corresponding to the handshake data 238 from the user communications device, to be indicative of a malicious intent on the part of the user or of an abstention attack, and, therefore, blocks access.

As time factor is involved in relation to the handshake response to the handshake data 238, there is, therefore, provided a time bound handshake process.

It should be appreciated that the determination that there is the abstention attack may be an active step of determining that there is such an attack, or the determination is a follow-through process as a consequence or conclusion derived from the combination of no handshake response corresponding to the handshake data 238 within the defined time duration and the presence of the event.

An event that is indicative of the user communications device being in a communication mode with the communications server apparatus 202 may include, but not limited to, at least one of (i) ongoing communication between the user communications device and the communications server apparatus 202, e.g., in relation to one or more other services associated with (or provided by) the communications server apparatus 202, (ii) the user communications device further attempting to access the communications server apparatus 102 or the service associated therewith, or attempting to communicate with the communications server apparatus 202, (iii) the user communications device making a call to a gateway of the communications server apparatus 202, (iv) the user communications device checking network calls, or (v) an open TCP (Transmission Control Protocol) connection. The check for the existence of an open communication/connection may be on the server apparatus; as it is known that a particular user was asked to respond to the (handshake) challenge, but has not responded, and if the same authentication token is sent for calls made to the APIs, this may trigger the detection on the server.

As non-limiting examples, it may be that there is no response at all from the user communications device (e.g., where the user evades sending a response), or the response that is sent by the user in response to the handshake data 238 is not an appropriate response or not a response that is expected, e.g., where the response may include data from the user communications device indicating at least one of the following: (i) that the agent (on the user communications device) for sending the handshake response has been modified or compromised, (ii) the App (application) that is being used to communicate with the communications server apparatus 202 has been modified or compromised, or (iii) the user communications device (or its operating system) has been modified or compromised. The “agent” on the user communications device may refer to a set of code or instructions resident on the user communications device.

In the context of various embodiments, the communications server apparatus 202 may set a start time for the defined time duration and/or store data indicative of the start time (e.g., in (the) one or more data stores). The start time may correspond to the time that the presence of the user of the user communications device is identified.

In the context of various embodiments, a service or microservice associated with the communications server apparatus 202 may include login, logging, business logic (multiple), etc.

In the context of various embodiments, transmission of the handshake data 238 to the user communications device and monitoring for the response may be by means of a fraud decision network (FDN) of the communications server apparatus 202. Generation of the termination data 239 may be by means of the FDN.

In various embodiments, for determining that there is the abstention attack, the communications server apparatus 202 may be configured to determine that there is the abstention attack in response to the expiry of the defined time duration with no handshake response having verification data (corresponding to the handshake data 238) being received by the communications server apparatus 202, and, further, in response to the communications server apparatus 202 determining the presence of the event. The verification data may be from an agent on the user communications device. The verification data may include data indicative of a status or condition of the user communications device and/or a status of the application (App) used by the user of the user communications device to communicate with the communications server apparatus 202, e.g., whether the App has been modified and/or the user communications device has undergone rooting or jailbreak. Examples of such data may include a checksum for checking whether the App is modified or not, data as to whether the device is rooted/jailbroken, etc.

In various embodiments, the handshake data 238 may include a nonce. The term “nonce” may refer to a code, a character, a number or a value that can be used (only) once for the purpose of authentication. The nonce may be used in a cryptographic communication, and may be encrypted by a specific or defined private key known only to the communications server apparatus 202 (e.g., known only to the FDN that forms part of the server apparatus 202). Information corresponding to the nonce may be stored in the communications server apparatus 202 (e.g., in the FDN). The nonce may be sent to the agent on the user communications device. Use of a nonce can avoid a replay attack so that old communication or response cannot be reused.

With the handshake data 238 having the nonce, the verification data (to be transmitted with the handshake response) may include a signed or response nonce corresponding to the nonce transmitted by the communications server apparatus 202.

In the context of various embodiments, the defined time duration may be in between about 2 minutes and about 10 minutes, for example, between about 2 minutes and about 8 minutes, between about 2 minutes and about 6 minutes, between about 2 minutes and about 5 minutes, between about 5 minutes and about 10 minutes, between about 5 minutes and about 8 minutes, or between about 3 minutes and about 6 minutes, e.g., about 2 minutes, about 3 minutes, about 5 minutes (preferably), about 6 minutes, about 8 minutes or about 10 minutes.

In various embodiments, prior to transmitting the handshake data 238 to the user communications device, the communications server apparatus 202 may be further configured to issue a session token to the user communications device. The session token may serve to identify or prove authentication of the user. The session token may be issued in response to the communications server apparatus 202 authenticating a user of the user communications device.

In the context of various embodiments, for authenticating a user of the user communications device, the communications server apparatus 202 may be configured to, in response to receiving user data (from the user communications device) having one or more data fields indicative of an identity of the user, authenticate the user based on the user data. The user data may include user id and password associated with the user.

The session token may be valid for all (micro)services associated with the communications server apparatus 202.

The session token may be issued by an identity provider (IDP) module of the communications server apparatus 202.

In the context of various embodiments, the IDP and FDN are sets or pieces of codes running on the communications server apparatus 202. The IDP and FDN may be different or separate from one another, or can be in one module.

In various embodiments, in response to the termination data 239 generated, the communications server apparatus 202 may be further configured to invalidate (or revoke) the session token. In other words, the communications server apparatus 202 may cause expiry of the session token to block access by the user communications device to the service associated with the communications server apparatus 202. The session token may be invalidated by the IDP module in response to an eviction verdict or notification issued by the FDN.

Prior to transmitting the handshake data 238 to the user communications device, and in response to the communications server apparatus 202 authenticating a user of the user communications device, the communications server apparatus 202 may be further configured to generate data to identify presence of the user, and store the data in one or more data stores (e.g., a data store may be a distributed hash table) in the communications server apparatus 202. As a non limiting example, the data may include a defined “key” and a defined value (e.g., a null value) associated with the key. The one or more data stores or distributed hash table(s) may be part of the FDN.

The data may include time data indicative of the time of identification of the presence of the user.

In various embodiments, in response to the handshake response (corresponding to the handshake data 238) being received by the communications server apparatus 202 within the defined time duration, the communications server apparatus 202 may be further configured to generate access data to allow the user communications device access to the service associated with the communications server apparatus 202. The response may include the verification data. The verification data may include a signed or response nonce corresponding to the nonce transmitted by the communications server apparatus 202 as part of the handshake data 238.

The communications server apparatus 202 may be further configured to generate second data indicative of the receipt of the handshake response by the communications server apparatus 202, and update the data stored in the one or more data stores with the second data. As a non-limiting example, the second data may include a second defined value (e.g., a non-null value) to be associated with the defined “key”.

As a non-limiting example, a handshake response may be received at any time within the defined time duration. If a handshake response is received within the defined time duration, the user may, for example, be removed from a lookup list. At the end of the defined time duration, any user that has not sent a handshake response may be deemed probable malicious and after further check(s), the user may be acted upon, for example, removed or evicted.

In the context of various embodiments, the communications server apparatus 202 may be a single server, or have the functionality performed by the communications server apparatus 202 distributed across multiple server components.

In the context of various embodiments, an “App” or an “application” may be installed on a user communications device and may include processor-executable instructions for execution on the device. As a non-limiting example, a user of the user communications device may attempt to communicate with the communications server apparatus 202 or to access a service associated with (or provided by) the communications server apparatus 202 via an App.

FIG. 2B shows a flow chart 240 illustrating a method, performed in a communications server apparatus for determination of an abstention attack associated with a user communications device.

At 242, handshake data is transmitted to the user communications device.

At 244, monitoring is carried out, for a defined time duration, for a handshake response from the user communications device corresponding to the handshake data.

In response to expiry of the defined time duration with no handshake response corresponding to the handshake data being received by the communications server apparatus, and, further, in response to determining presence of an event that is indicative of the user communications device being in a communication mode with the communications server apparatus, at 246, it is determined that there is the abstention attack, and at 248, termination data is generated in response to the determination of the abstention attack for denying the user communications device access to a service associated with the communications server apparatus.

At 246, it may be determined that there is the abstention attack in response to the expiry of the defined time duration with no handshake response having verification data being received by the communications server apparatus, and, further, in response to determining the presence of the event.

At 242, the handshake data including a nonce may be transmitted to the user communications device.

In various embodiments, the defined time duration may be in between about 2 minutes and about 10 minutes, for example, between about 2 minutes and about 8 minutes, between about 2 minutes and about 6 minutes, between about 2 minutes and about 5 minutes, between about 5 minutes and about 10 minutes, between about 5 minutes and about 8 minutes, or between about 3 minutes and about 6 minutes, e.g., about 2 minutes, about 3 minutes, about 5 minutes (preferably), about 6 minutes, about 8 minutes or about 10 minutes.

Prior to transmitting the handshake data to the user communications device at 242, the method may further include issuing a session token to the user communications device.

In response to the termination data generated, the method may further include invalidating the session token.

Prior to transmitting the handshake data to the user communications device at 242, and in response to authentication of a user of the user communications device, the method may further include generating data to identify presence of the user, and storing the data in one or more data stores in the communications server apparatus.

The data may include time data indicative of the time of identification of the presence of the user.

In response to the handshake response being received by the communications server apparatus within the defined time duration, access data may be generated to allow the user communications device access to the service associated with the communications server apparatus.

Second data indicative of the receipt of the handshake response by the communications server apparatus may be generated, and the data stored in the one or more data stores may be updated with the second data.

It should be appreciated that descriptions in the context of the communications server apparatus 202 may correspondingly be applicable in relation to the method as described in the context of the flow chart 240.

It should be appreciated that descriptions in the context of the communications server apparatus 102 may correspondingly be applicable in relation to the communications server apparatus 202.

In the context of various embodiments, a user communications device may include, but not limited to, a smart phone, tablet, handheld/portable communications device, desktop or laptop computer, terminal computer, etc.

There may also be provided a computer program product having instructions for implementing a method for determination of an abstention attack associated with a user communications device as described herein.

There may also be provided a computer program having instructions for implementing a method for determination of an abstention attack associated with a user communications device as described herein.

There may further be provided a non-transitory storage medium storing instructions, which, when executed by a processor, cause the processor to perform a method for determination of an abstention attack associated with a user communications device as described herein.

Various embodiments or techniques will now be further described in detail.

The techniques disclosed herein may involve implementing a time bound handshake process between the following systems or modules: an Identity provider (IDP), a Fraud Decision Network (FDN), and an agent on a user device.

The IDP may be responsible for Login so the IDP may act as a Gateway.

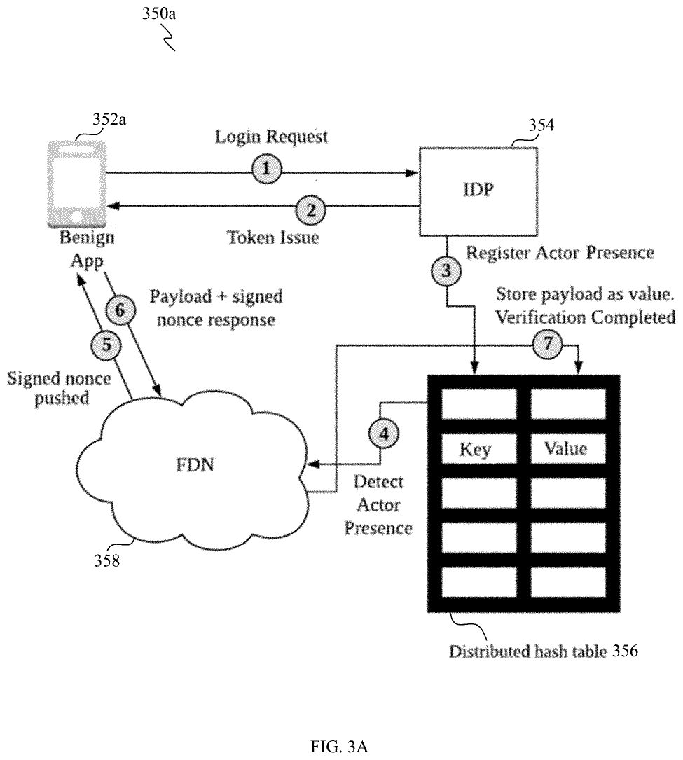

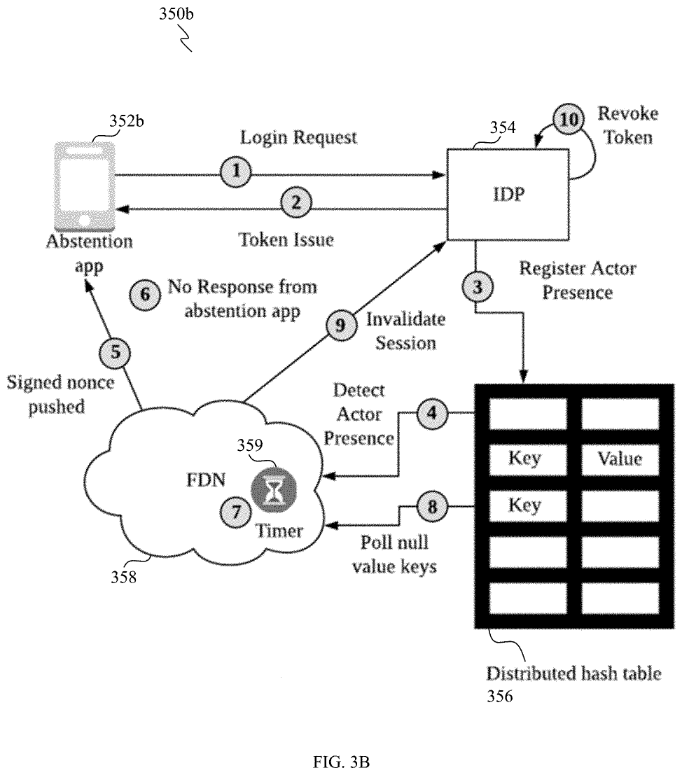

FIG. 3A shows a schematic diagram 350a illustrating a benign App flow sequence, while FIG. 3B shows a schematic diagram 350b illustrating an abstention App flow sequence.

Referring first to FIG. 3A, the process starts with the user communications device 352a connecting to the IDP 354 for issuing a session token (1, corresponding to the directional arrow of the same number (in circle) in FIG. 3A). The IDP 354 may authenticate the user and identify the user (a valid authentication leads to identification of the user), and may then issue a session token (2) and may record (3) the presence of this actor or user on the network to a distributed hash table 356. The hash table 356 may currently record the key, but may assign a null value for the pair of key-value, indicating that the actor is present on the network pending verification. The timestamp of this event may be recorded and tracked for bounds checking.

The IDP session token or session cookie may be of any type to identify authentication, including in the form of a JWT (JSON Web Token). The token may be required to prove authentication and may be needed in all requests to background.

The IDP session token may be valid for all (micro)services in the backend.

The Fraud Decision Network (FDN) 358 may sense the presence of the actor (4) and may now issue a cryptographic nonce (5) encrypted by a specific private key known only to the FDN 358. The nonce is sent to a specific agent on the device 352a as a response. In various embodiments, when a user/actor logs in, the IDP 354 may inform the FDN 358 of the presence of the actor. The FDN 358 may store information relating to the user, and the nonce information.

If the actor is benign, the agent sends this signed nonce back to the server (i.e., FDN 358) along with the response payload (6). This response is recorded in the distributed hash table 356 against the identity of the user as a value for the corresponding key (7). The need for a nonce is to avoid a replay attack where the fraudster can copy a previous response payload and send the same one to the FDN 358. The process then continues that allows the device 352a to access the desired service.

The nonce may be or include a Message Authentication Code that is sent from the FDN 358 to the client device 352a. For the return signed nonce, the same message is expected to be returned by the client 352a back to the FDN 358 as part of the payload from the client 352a. This is to make sure that the payload is generated at a specific time and not “replayed” (e.g., using a previous response or payload).

The same message is expected to be returned by the client 352a back to the FDN as part of the payload.

It should be appreciated that, while the distributed hash table 356 is shown separate from the FDN 358, the distributed hash table 356 may be part of the FDN 358.

It should be appreciated that one or more distributed hash tables (e.g., each being similar to the distributed hash table 356) may be provided for storing data.

The IDP 354 and the FDN 358 are resident on a communications server apparatus, e.g., on the same server. The IDP 354 and the FDN 358 are pieces of code that are running on a communications server apparatus. The IDP 354 and the FDN 358 may be different modules or they can be in one module.

Referring now to FIG. 3B, (1) to (5) are the same as those of FIG. 3A and description thereof is therefore omitted. If the agent on the user communications device 352b has been altered (e.g., modified to stop sending a response or payload), or if the actor/user tries to evade sending the payload, where there is no response from the abstention App (6), the FDN 358 waits until a timer 359 expires (7). Expiry of the timer 359 means that a certain time duration has passed or elapsed without the payload being received. As a non-limiting example, there may be a time duration of 5 minutes to expiry of the timer 359. The FDN 358 may store the time when the IDP 354 informs the actor's presence as the reference or basis for the timer 359.

All normal or non-malicious clients (or users) are expected to respond with data from the device. Only malicious actors would not send a response (or payload), and the omission of act of sending a response is detected on the FDN 358.

After the expiry of the timer 359, the FDN 358 may then check for presence of one or more network events from the actor/user, which could be in the form of checking network calls or open TCP connections. Another network event may be where the FDN 358 determines that there are still active connections to other services in the mesh of microservices. This may be done, for example, by looking at the API G/W (Application Programming Interface Gateway), which may act as a gateway to all the microservices in the ecosystem. In various embodiments, the API G/W may be a software component that acts like a gateway to all the API calls. The existence of a call to the G/W may be an indication of a malicious intent after a certain amount of time.

If active network events are detected and there has been no payload response from the actor, which is indicated by a null value for the key on the distributed hash table 356 (8), the FDN 358 issues an eviction verdict for this specific actor (9). The IDP 354 may then act on the eviction verdict and removes the actor from the network by invalidating the current session (which is valid for all (micro)services in the backend) by revoking (or expiring) the session token (10). As a non-limiting example, a session token has a session validity and this may be checked every time a call is made by the user device 352b. If the token session is invalidated on the server, the next time the user makes a call, via the user device 352b, it is determined that the session token is no longer valid, and so the session is terminated.

Effectively, an abstention attack may be detected if the user or actor is not sending the required payload, but remains present or available in the system.

In various embodiments, the total number of logins and the number of payload received may be tracked. These numbers should, ideally, be equal, but there can be loss due to network issues. However, if the number of payload received is too low compared to the number of logins, action may be taken to logout the actor/user.

As described above, the techniques disclosed herein may provide a methodology of addressing or solving an abstention attack, e.g., on a mobile fraud prevention network.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A communications server apparatus for determination of an abstention attack associated with a user communications device, the communications server apparatus comprising a processor and a memory, the communications server apparatus being configured, under control of the processor, to execute instructions in the memory to:
transmit handshake data comprising a nonce to the user communications device;
monitor, for a defined time duration, for a handshake response from the user communications device corresponding to the handshake data; and
in response to expiry of the defined time duration with no handshake response corresponding to the handshake data being received by the communications server apparatus, and, further, in response to the communications server apparatus determining presence of an event that is indicative of the user communications device being in a communication mode with the communications server apparatus,
determine that there is the abstention attack; and
generate termination data in response to the determination of the abstention attack for denying the user communications device access to a service associated with the communications server apparatus.

2. The communications server apparatus as claimed in claim 1,
wherein, for determining that there is the abstention attack, the communications server apparatus is configured to determine that there is the abstention attack in response to the expiry of the defined time duration with no handshake response comprising verification data being received by the communications server apparatus, and, further, in response to the communications server apparatus determining the presence of the event.

3. The communications server apparatus as claimed in claim 1, wherein the defined time duration is in between about 2 minutes and about 10 minutes.

4. The communications server apparatus as claimed in claim 1, wherein, prior to transmitting the handshake data to the user communications device, the communications server apparatus is further configured to issue a session token to the user communications device.

5. The communications server apparatus as claimed in claim 4,
wherein in response to the termination data generated, the communications server apparatus is further configured to invalidate the session token.

6. The communications server apparatus as claimed in claim 1, wherein, prior to transmitting the handshake data to the user communications device, and in response to the communications server apparatus authenticating a user of the user communications device, the communications server apparatus is further configured to:
generate data to identify presence of the user; and
store the data in one or more data stores in the communications server apparatus.

7. The communications server apparatus as claimed in claim 6, wherein the data comprises time data indicative of the time of identification of the presence of the user.

8. The communications server apparatus as claimed in claim 1,
wherein in response to the handshake response being received by the communications server apparatus within the defined time duration, the communications server apparatus is further configured to generate access data to allow the user communications device access to the service associated with the communications server apparatus.

9. The communications server apparatus as claimed in claim 8,
wherein, prior to transmitting the handshake data to the user communications device, and in response to the communications server apparatus authenticating a user of the user communications device, the communications server apparatus is further configured to:
generate data to identify presence of the user; and
store the data in one or more data stores in the communications server apparatus. and
wherein the communications server apparatus is further configured to:
generate second data indicative of the receipt of the handshake response by the communications server apparatus; and
update the data stored in the one or more data stores with the second data.

10. A method, performed in a communications server apparatus for determination of an abstention attack associated with a user communications device, the method comprising, under control of a processor of the communications server apparatus:
transmitting handshake data comprising a nonce to the user communications device;
monitoring, for a defined time duration, for a handshake response from the user communications device corresponding to the handshake data; and
in response to expiry of the defined time duration with no handshake response corresponding to the handshake data being received by the communications server apparatus, and, further, in response to determining presence of an event that is indicative of the user communications device being in a communication mode with the communications server apparatus,
determining that there is the abstention attack; and
generating termination data in response to the determination of the abstention attack for denying the user communications device access to a service associated with the communications server apparatus.

11. The method as claimed in claim 10,
wherein determining that there is the abstention attack comprises determining that there is the abstention attack in response to the expiry of the defined time duration with no handshake response comprising verification data being received by the communications server apparatus, and, further, in response to determining the presence of the event.

12. The method as claimed in claim 10, wherein the defined time duration is in between about 2 minutes and about 10 minutes.

13. The method as claimed in claim 10,
wherein, prior to transmitting the handshake data to the user communications device, the method further comprises issuing a session token to the user communications device.

14. The method as claimed in claim 13,
wherein in response to the termination data generated, the method further comprises invalidating the session token.

15. The method as claimed in claim 10, wherein, prior to transmitting the handshake data to the user communications device, and in response to authentication of a user of the user communications device, the method further comprises:
generating data to identify presence of the user; and
storing the data in one or more data stores in the communications server apparatus.

16. The method as claimed in claim 15, wherein the data comprises time data indicative of the time of identification of the presence of the user.

17. The method as claimed in claim 10,
wherein in response to the handshake response being received by the communications server apparatus within the defined time duration, the method further comprises generating access data to allow the user communications device access to the service associated with the communications server apparatus.

18. The method as claimed in claim 17,
wherein, prior to transmitting the handshake data to the user communications device, and in response to authentication of a user of the user communications device, the method further comprises:
generating data to identify presence of the user; and
storing the data in one or more data stores in the communications server apparatus, and
wherein the method further comprises:
generating second data indicative of the receipt of the handshake response by the communications server apparatus; and
updating the data stored in the one or more data stores with the second data.

19. A computer program or a computer program product comprising instructions for implementing the method as claimed in claim 10.

20. A non-transitory storage medium storing instructions, which when executed by a processor cause the processor to perform the method as claimed in claim 10.
